(19) United States
(12) Patent Application Publication
(10) Pub. No.: US 2014/0055569 A1
(43) Pub. Date: Feb. 27, 2014

(54) APPARATUS AND METHOD FOR SENSING DROWSY DRIVING

(71) Applicant: SAMSUNG ELECTRO-MECHANICS CO., LTD., Suwon (KR)

(72) Inventors: Hae Jin JEON, Suwon (KR); In Taek SONG, Suwon (KR)

(73) Assignee: SAMSUNG ELECTRO-MECHANICS CO., LTD., Suwon (KR)

(21) Appl. No.: 13/705,372

(22) Filed: Dec. 5, 2012

(30) Foreign Application Priority Data
Aug. 22, 2012 (KR) 10-2012-0091967

(51) Int. Cl. H04N 13/02

(52) U.S. Cl. CPC H04N 13/0203
USPC 348/47

(57) ABSTRACT

There are provided an apparatus and a method for sensing drowsy driving, the apparatus for sensing drowsy driving including: a light source irradiating light on a driver; first cameras sensing light reflected from the driver to image eyes of the driver; a second camera disposed to be spaced apart from the first cameras by a predetermined distance and sensing the light reflected from the driver to image a face of the driver; and a calculating unit generating depth information from the light sensed by the second camera to recognize the face of the driver as a three-dimensional stereoscopic image and determining whether the driver is driving while drowsy from whether the eyes of the driver imaged by the first camera are opened or closed and a position of the face of the driver imaged by the second camera.

### CROSS-REFERENCE TO RELATED APPLICATIONS

This application claims the priority of Korean Patent Application No. 10-2012-0091967 filed on Aug. 22, 2012, in the Korean Intellectual Property Office, the disclosure of which is incorporated herein by reference.

### BACKGROUND OF THE INVENTION

1. Field of the Invention

The present invention relates to an apparatus and a method for sensing drowsy driving.

2. Description of the Related Art

Recently, in the automotive field, efforts to improve automobile stability and driver convenience while protecting pedestrians have been made. Therefore, generally, a system in which various sensors are provided on the inside and outside of an automobile, or the like to recognize surrounding environments, has been introduced into the automobile field for the safety of automobile drivers and passengers.

Particularly, a case in which the driver is driving while drowsy due to insufficient sleep, fatigue caused by labor for a long time, or the intake of drugs occurs. Since this drowsy driving may cause a fatal accident, a number of drowsy driving recognition systems have been developed in order to prevent drowsy driving.

As the drowsy driving recognizing systems, several methods such as a method of using an oxygen sensor sensing an amount of oxygen, an automobile speed sensor, a heart rate measuring sensor, an image processing method using a charged coupled device (CCD) camera, and the like, have been suggested.

In the case in which it is determined whether or not a driver is driving while drowsy by recognizing the driver's face with a CCD camera, the CCD camera may be blocked by an attitude of the driver, such that the face of the driver may not be recognized. In addition, since the face of the driver is determined by a two-dimensional image, accuracy may be low.

### RELATED ART DOCUMENT

(Patent Document 1) Japanese Patent Laid-Open Publication No. 2011-43961
(Patent Document 2) Korean Patent Laid-Open Publication No. 2010-0121173

### SUMMARY OF THE INVENTION

An aspect of the present invention provides an apparatus and an method for sensing drowsy driving, that include a first camera imaging eyes of a driver and a second camera imaging a face of the driver as a three-dimensional stereoscopic image by sensing light to generate depth information, thereby determining whether the driver is driving while drowsy from whether the eyes of the driver imaged by the first camera are opened or closed and a position, a rotation angle, a movement speed, and the like, of the face of the driver imaged by the second camera.

According to an aspect of the present invention, there is provided an apparatus for sensing drowsy driving including: a light source irradiating light on a driver; first cameras sensing light reflected from the driver to image eyes of the driver; a second camera disposed to be spaced apart from the first cameras by a predetermined distance and sensing the light reflected from the driver to image a face of the driver; and a calculating unit generating depth information from the light sensed by the second camera to recognize the face of the driver as a three-dimensional stereoscopic image and determining whether the driver is driving while drowsy from whether the eyes of the driver imaged by the first camera are opened or closed and a position of the face of the driver imaged by the second camera.

The first cameras maybe disposed disposed to left and right of the second camera, respectively.

The calculating unit may determine that the driver is driving while drowsy when the eyes of the driver imaged by the first cameras are closed for a preset time or more.

The calculating unit may determine a distance between the light source and the driver using a phase difference between the light irradiated by the light source and the light sensed by the second camera.

The calculating unit may determine at least one of a rotation angle of the face of the driver, a position of the face of the driver, and a movement speed of the face of the driver from the three-dimensional stereoscopic image of the face of the driver.

The first camera may sense infrared light.

The second camera may be a time-of-flight (TOF) camera.

According to another aspect of the present invention, there is provided a method for sensing drowsy driving including: sensing light reflected from a driver by first and second cameras; generating information on whether eyes of the driver are opened or closed from the light sensed by the first camera; generating depth information from the light sensed by the second camera to generate a face of the driver as a three-dimensional stereoscopic image; and determining whether the driver is driving while drowsy from the information on whether the eyes of the driver are opened or closed and the three-dimensional stereoscopic image of the face of the driver.

In the determining of whether the driver is driving while drowsy, it may be determined that the driver is driving while drowsy when the eyes of the driver are closed for a preset time or more.

In the generating of the depth information, the depth information including a distance between a light source and an object maybe generated using a phase difference between light irradiated by the light source and the sensed light.

In the determining of whether the driver is driving while drowsy, at least one of a rotation angle of the face of the driver, a position of the face of the driver, and a movement speed of the face of the driver may be determined from the three-dimensional stereoscopic image of the face of the driver.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are diagrams showing positions of cameras of an apparatus for sensing drowsy driving according to an embodiment of the present invention;

FIG. 3 is a block diagram for describing a first camera in an apparatus for sensing drowsy driving according to another embodiment of the present invention;

FIG. 4 is a diagram for describing a second camera in the apparatus for sensing drowsy driving according to the embodiment of the present invention;

FIG. 5 is a diagram showing an image output by the apparatus for sensing drowsy driving according to the embodiment of the present invention; and

FIG. 6 is a flow chart describing a method for sensing drowsy driving according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

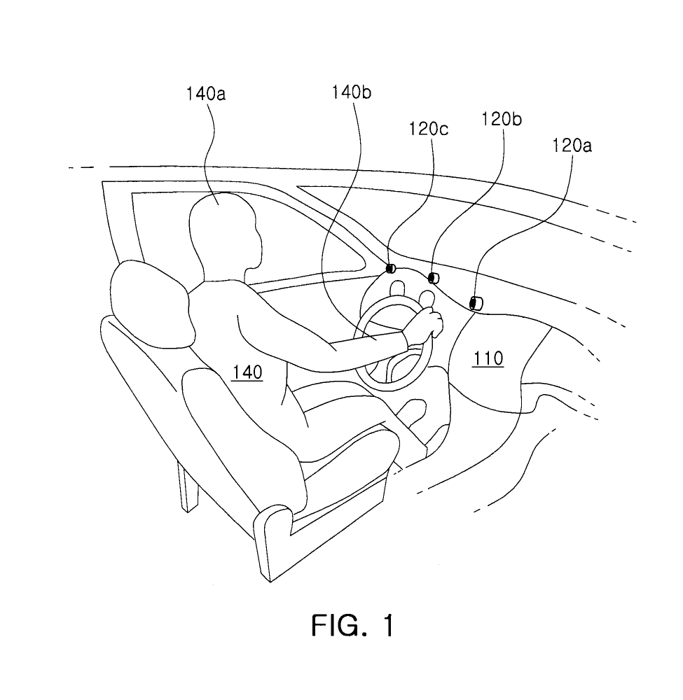

FIGS. 1 and 2 are diagrams showing positions of cameras of an apparatus for sensing drowsy driving according to an embodiment of the present invention.

Referring to FIG. 1, the apparatus for sensing drowsy driving according to the embodiment of the present invention may include a light source (not shown), first cameras 120a and 120c, and a second camera 120b, and a calculating unit (not shown). The apparatus for sensing drowsy driving may be disposed in an automobile 110, and the first cameras 120a and 120c and the second camera 120b may be disposed in front of a driver 140 in order to image the driver 140. Although not shown, the light source may be disposed at the opposite side of the driver 140 so as to irradiate light onto a face of the driver 140 and be disposed together with the first cameras 120a and 120c and the second camera 120b.

The first cameras 120a and 120c that are provided to determine whether eyes of the driver 140 are opened or closed, may be infrared cameras sensing infrared light reflected from the driver 140. The second camera 120b maybe a camera sensing the light reflected from the driver 140 to generate depth information. The apparatus for sensing drowsy driving according to the embodiment of the present invention includes a plurality of the cameras 120a, 120b, and 120c, such that even in the case that one of the cameras does not recognize the reflected light due to an obstacle such as an arm 140b of the driver, other cameras may auxiliarily recognize the face 140a of the driver. In addition, in the apparatus for sensing drowsy driving according to the embodiment of the present invention, depth information may generated by the camera 120b disposed in front of the face 140a of the driver among the plurality of cameras, whereby an accurate position of the face 140a and a movement speed of the face 140a may be calculated.

The first cameras 120a and 120c included in the apparatus for sensing drowsy driving may be provided in plural and disposed to the left and the right of the second camera 120b, respectively.

FIG. 2 shows view angles according to disposition of the first cameras 120a and 120c and the second camera 120b. Referring to FIG. 2, the second camera 120b outputting a three-dimensional stereoscopic image may be disposed at the opposite side of the face 140a of the driver 140 and image the front of the face 140a of the driver. In addition, the first cameras 120a and 120c may be disposed to the left and to the right of the second camera 120b, respectively, and image a front and both sides of the face 140a of the driver. That is, the plurality of cameras 120a, 120b, and 120c are disposed in all directions, such that the entire surface of the face 140a of the driver may be monitored and the face 140a of the driver may be imaged by the other first camera even in the case that the arm 140b of the driver blocks one of the first cameras.

Hereinafter, throughout the present specification, the term “depth information” may be interpreted as meaning a distance from the second camera 120b to an object, that is, the driver 140. The depth information may be calculated by a calculating unit from a phase difference between light output from the light source and light sensed by the second camera 120b and refer to a distance from the second camera 120b to a specific point of the object.

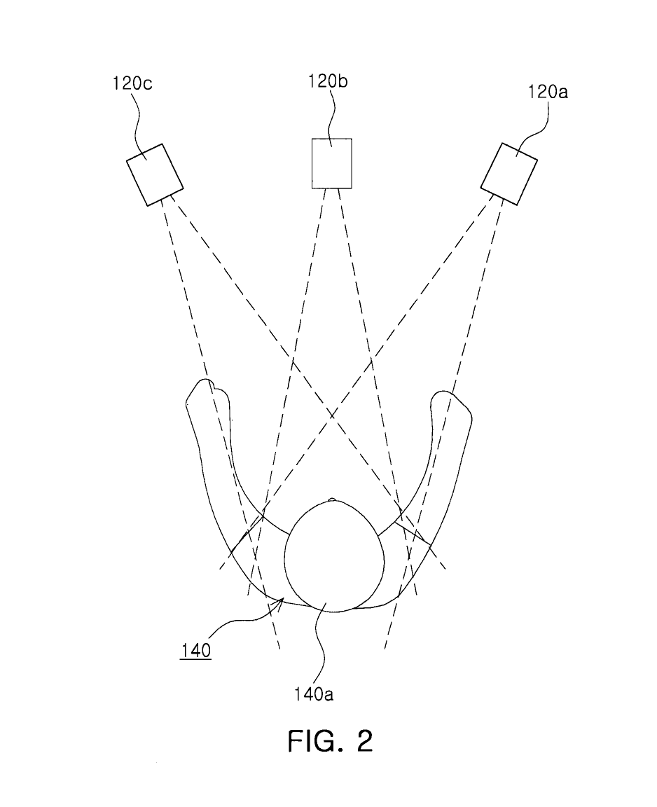

Hereinafter, a method of sensing whether the eyes of the driver are opened or closed using a first camera will be described with reference to FIG. 3.

FIG. 3 is a block diagram for describing a first camera in an apparatus for sensing drowsy driving according to another embodiment of the present invention.

Referring to FIG. 3, a first camera 310 may include an infrared (IR) light source 315, an image sensor 313, and a light source driving unit 317. The IR light source 315 may emit infrared light and the emitting of light may be controlled by the light source driving unit 317. The light emitted by the IR light source 315 may be reflected and returned when the light collides with a specific object, and the image sensor 313 may sense the reflected light.

Image information regarding eyes of the driver obtained from the light sensed by the image sensor 313 may be transferred to a control unit 330. The control unit 330 may include a digital signal processor (DSP) 333, a static random access memory (SRAM) 335, a flash memory 337, and an external interface (I/F) 339. A portion of the image information processed by the digital signal processor 333 may be stored in the SRAM 335 in which a stored content is memorized only during a time at which power is supplied, and the other portion of the image information processed by the digital signal processor 333 may be stored in the flash memory 337 in which stored information is maintained without being vanished even in the case that a power supply is turned off.

A result of image processed by the digital signal processor 333 may be transferred to an automobile main electronic control unit (ECU), which is a control device controlling a state of an engine, an automatic transmission, an anti-lock braking system, and the like, of an automobile, through the external I/F 339.

Whether or not the driver is driving while drowsy may be determined according to whether the eyes of the driver sensed by the first camera are opened or closed. In the case in which the eyes of the driver are closed for a preset reference time, it may be determined that the driver is driving while drowsy.

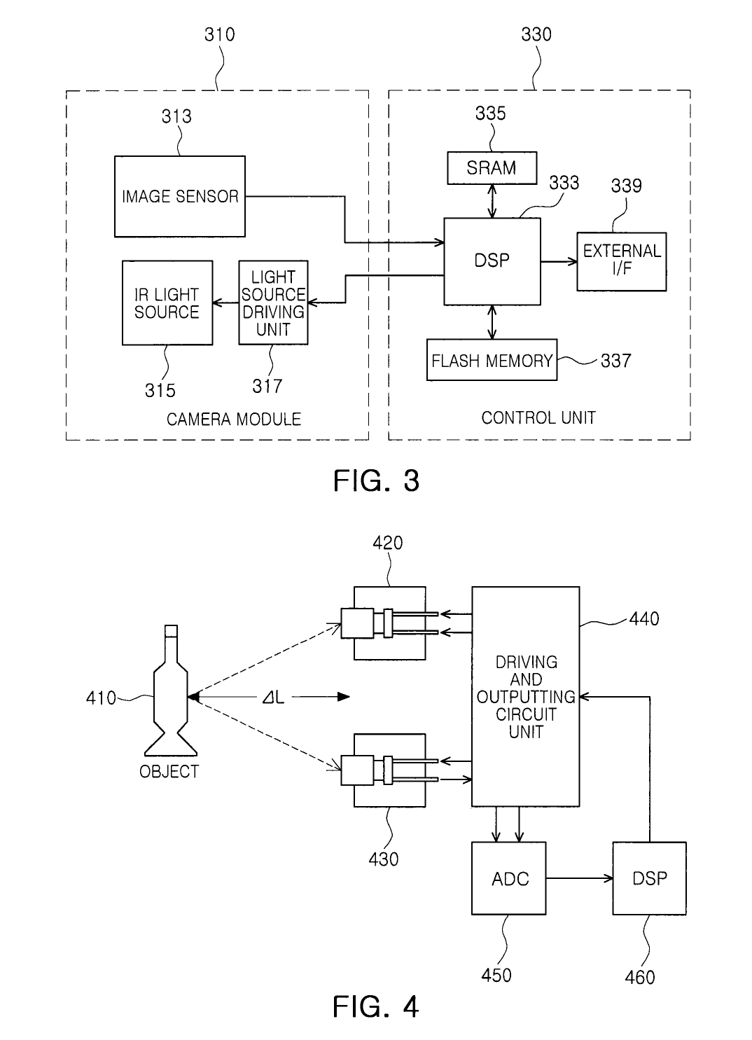

Hereinafter, a method of outputting the face of the driver as a three-dimensional stereoscopic image from the second camera will be described with reference to FIG. 4.

FIG. 4 is a diagram for describing a second camera in the apparatus for sensing drowsy driving according to the embodiment of the present invention.

Referring to FIG. 4, the second camera may be a time-of-flight (TOF) camera and include a light emitting diode (LED) array 420, a TOF sensor array 430, a driving and outputting circuit unit 440, an analog signal processing unit 450, and a digital signal processing unit 460. The driving and outputting circuit unit 440, the analog signal processing unit 450, and the digital signal processing unit 460 may be represented by a single calculating unit.

The LED array 420 may be a light source emitting light and emit light having a period and a phase, for example, infrared light. Theoretically, the LED array 420 may emit a square wave signal having a turn-on time and a turn-off time provided as half periods as the light and may actually emit a sine wave signal as the light. The light emitted by the LED array 420 may be reflected and return when the light collides with a specific object and the TOF sensor array 430 may sense the reflected light.

The TOF sensor array 430 may be formed of at least one light receiving sensor and the light receiving sensor in the TOF sensor array 430 may be implemented by a photo-diode.

The calculating unit may generate depth information from the light sensed by the TOF sensor array 430. The calculating unit may generate the depth information corresponding to a distance from the LED array 420 and the TOF sensor array 430 to an object reflecting the light using a phase difference between the light emitted by the LED array 420 and the light sensed by the TOF sensor array 430. Since phases of light respectively reflected by a plurality of objects 410 are different according to the distance from the LED array 420 and the TOF array 430, the calculating unit may generate the depth information regarding the plurality of objects 410. Pieces of the depth information regarding the plurality of objects 410 maybe synthesized with each other in a form of a single depth image.

Although the control unit calculating the image information sensed in the first camera and the calculating unit calculating the image information sensed in the second camera are separately shown in FIGS. 3 and 4 for the convenience of explanation, the image information sensed in the first camera and the image information sensed in the second camera may be calculated together in a single control unit.

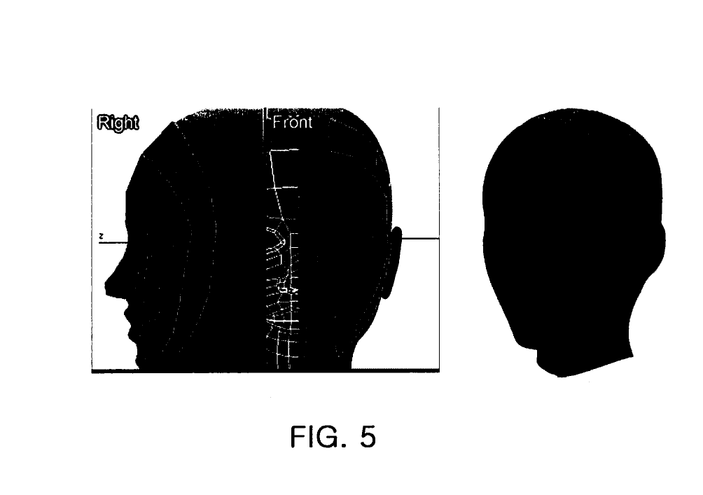

FIG. 5 is a diagram showing an image output by the apparatus for sensing drowsy driving according to the embodiment of the present invention.

The calculating unit may generate the face of the driver as a three-dimensional stereoscopic image using the depth information generated from the second camera.

The calculating unit may determine at least one of a rotation angle of the face of the driver represented as the three-dimensional stereoscopic image, a position of the face of the driver, and a movement speed of the face of the driver. In this case, the image regarding the face of the driver may be processed, based on a nose of the driver that is the closest to the second camera in the three-dimensional stereoscopic image of the face, such that an efficient algorithm may be implemented.

In the case in which it is determined whether the eyes of the driver are opened or closed according to the rotation angle of the face of the driver and the position of the face of the driver, it may be accurately determined whether or not the eyes of the driver are closed. Further, in the case in which the driver is driving while drowsy, the face of the driver moves forward. In this case, the movement speed is calculated, such that it may be determined whether or not the driver is driving while drowsy.

The face of the driver is generated as the three-dimensional stereoscopic image, whereby a facial shape of the driver may be accurately determined. Therefore, top and bottom and left and right rotation angles of the face of the driver may be accurately determined.

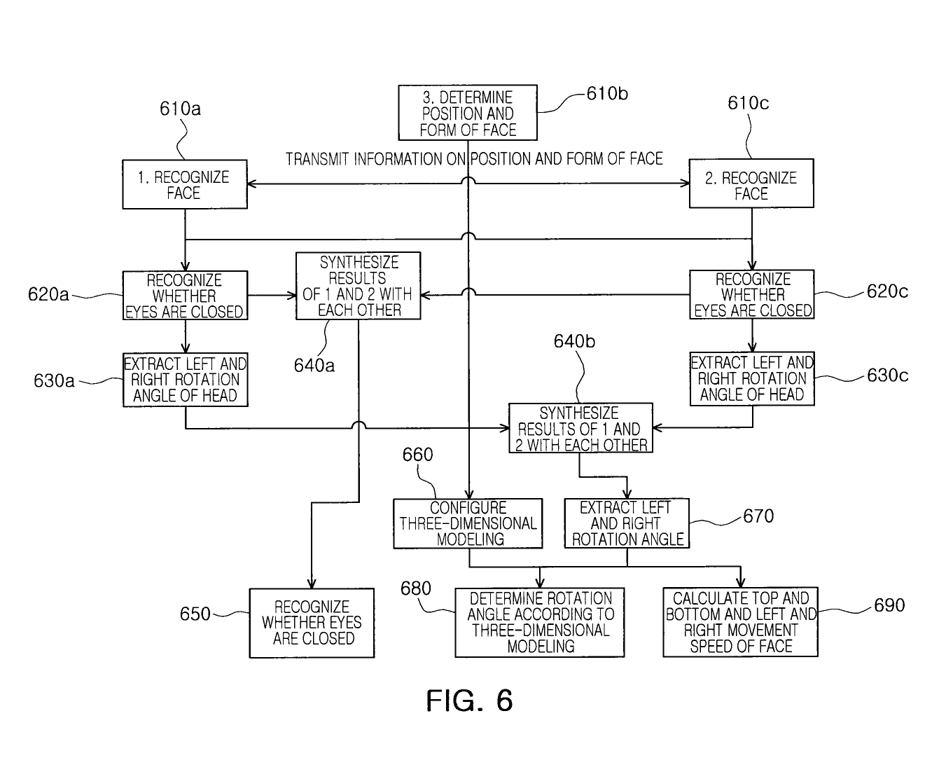

FIG. 6 is a flow chart describing a method for sensing drowsy driving according to an embodiment of the present invention.

Referring to FIG. 6, the method for sensing drowsy driving according to the embodiment of the present invention starts with sensing light reflected from a driver by a second camera and first cameras respectively disposed to the left and the right of the second camera, to recognize a face of the driver (610A, 610B, and 610C).

The first camera disposed to the left and the first camera disposed to the right sense the infrared light reflected from the driver to sense whether eyes of the driver are closed (620A and 620B). The first cameras are provided in plural and the plurality of first cameras may be disposed to the left and to the right, such that even in the case that an arm of the driver blocks one of the first cameras, the other first camera performs an auxiliary role, whereby an error due to the blocking of a screen of the camera may be prevented.

Image information obtained from the light sensed by the first camera disposed to the left and image information obtained from the light sensed by the first camera disposed to the right may be synthesized to determine whether the eyes of the driver are opened or closed (640A). In the synthesizing of the image information sensed in the first camera disposed to the left and the image information sensed in the first camera disposed to the right, image information having a higher recognition rate determining index may be selected, among the image information sensed in the first camera disposed to the left and the image information sensed in the first camera disposed to the right. Here, the recognition rate determining index means a matching rate with a basic learning pattern for determining the face of the driver. In the case in which the eyes of the driver are closed for a preset time or more, it may be determined that the driver is driving while drowsy (650).

The left and right rotation angles of the face of the driver may be extracted from the image information sensed in the first camera disposed to the left and the image information sensed in the first camera disposed to the right (630A and 630C). Among the rotation angle of the face of the driver extracted from the first camera disposed to the left and the rotation angle of the face of the driver extracted from the first camera disposed to the right, the rotation angle according to image information having a higher recognition rate determining index may be selected (640B and 670).

The second camera may sense the light reflected from the face of the driver and generate depth information regarding the face of the driver from the sensed light. The light having a predetermined period and phase is emitted to the face of the driver, and the emitted light collides with the face of the driver and is then reflected and returns. The depth information corresponding to the distance from the second camera to the face of the driver reflecting the light may be generated using a phase difference of the light sensed by the second camera. More specifically, since phases of the light reflected from the face of the driver are different according to distances from the second camera, the depth information regarding the face of the driver may be generated. The face of the driver may be output as a three-dimensional stereoscopic image from the depth information sensed in the second camera (660).

Next, the left and right rotation angle of the face of the driver extracted from the first cameras and a three-dimensional stereoscopic image of the face of the driver extracted from the second camera may be synthesized to determine a rotation angle of the face of the driver (680). In this case, a reference point is determined according to the three-dimensional stereoscopic image and the rotation angle is then determined, whereby the rotation angle may be more accurately detected as compared with the case in which the rotation angle is determined according to a two-dimensional image.

In addition, the top and bottom and left and right movement speeds of the face of the driver may be calculated from the three-dimensional stereoscopic image (690). A rate at which the face of the driver is changed may be calculated to detect that a specific situation has been generated to the driver.

As set forth above, the apparatus and the method for sensing drowsy driving according to the embodiment of the present invention include the first camera imaging the eyes of the driver and the second camera imaging the face of the driver as a three-dimensional stereoscopic image by sensing the light to generate the depth information, whereby it may be determined whether the driver is driving while drowsy from whether the eyes of the driver imaged by the first camera are opened or closed and the position, the rotation angle, the movement speed, and the like, of the face of the driver imaged by the second camera.

While the present invention has been shown and described in connection with the embodiments, it will be apparent to those skilled in the art that modifications and variations can be made without departing from the spirit and scope of the invention as defined by the appended claims.

What is claimed is:

1. An apparatus for sensing drowsy driving comprising:
a light source irradiating light on a driver;
first cameras sensing light reflected from the driver to image eyes of the driver;
a second camera disposed to be spaced apart from the first cameras by a predetermined distance and sensing the light reflected from the driver to image a face of the driver; and
a calculating unit generating depth information from the light sensed by the second camera to recognize the face of the driver as a three-dimensional stereoscopic image and determining whether the driver is driving while drowsy from whether the eyes of the driver imaged by the first camera are opened or closed and a position of the face of the driver imaged by the second camera.

2. The apparatus for sensing drowsy driving of claim 1, wherein the first cameras are disposed to left and right of the second camera, respectively.

3. The apparatus for sensing drowsy driving of claim 1, wherein the calculating unit determines that the driver is driving while drowsy when the eyes of the driver imaged by the first cameras are closed for a preset time or more.

4. The apparatus for sensing drowsy driving of claim 1, wherein the calculating unit determines a distance between the light source and the driver using a phase difference between the light irradiated by the light source and the light sensed by the second camera.

5. The apparatus for sensing drowsy driving of claim 4, wherein the calculating unit determines at least one of a rotation angle of the face of the driver, a position of the face of the driver, and a movement speed of the face of the driver from the three-dimensional stereoscopic image of the face of the driver.

6. The apparatus for sensing drowsy driving of claim 1, wherein the first cameras sense infrared light.

7. The apparatus for sensing drowsy driving of claim 1, wherein the second camera is a time-of-flight (TOF) camera.

8. A method for sensing drowsy driving comprising:
sensing light reflected from a driver by first and second cameras;
generating information on whether eyes of the driver are opened or closed from the light sensed by the first camera;
generating depth information from the light sensed by the second camera to generate a face of the driver as a three-dimensional stereoscopic image; and
determining whether the driver is driving while drowsy from the information on whether the eyes of the driver are opened or closed and the three-dimensional stereoscopic image of the face of the driver.

9. The method for sensing drowsy driving of claim 8, wherein in the determining of whether the driver is driving while drowsy, it is determined that the driver is driving while drowsy when the eyes of the driver are closed for a preset time or more.

10. The method for sensing drowsy driving of claim 8, wherein in the generating of the depth information, the depth information including a distance between a light source and an object is generated using a phase difference between light irradiated by the light source and the sensed light.

11. The method for sensing drowsy driving of claim 8, wherein in the determining of whether the driver is driving while drowsy, at least one of a rotation angle of the face of the driver, a position of the face of the driver, and a movement speed of the face of the driver is determined from the three-dimensional stereoscopic image of the face of the driver.
